(19) United States
(12) Patent Application Publication
(10) Pub. No.: US 2023/0089337 A1
(43) Pub. Date: Mar. 23, 2023

(54) METHOD AND APPARATUS FOR LOCATION-BASED CROWDFUNDING

(71) Applicant: Habitech Ltd, Jerusalem (IL)

(72) Inventor: Yair WINKLER, Jerusalem (IL)

(73) Assignee: Habitech Ltd, Jerusalem (IL)

(21) Appl. No.: 17/798,351

(22) PCT Filed: Feb. 9, 2021
(86) PCT No.: PCT/IL21/50156

§ 371 Date: Aug. 9, 2022

Related U.S. Application Data
(60) Provisional application No. 62/972,003, filed on Feb. 9, 2020.

(51) Int. Cl. G06Q 20/40

(52) U.S. Cl. CPC G06Q 20/4014; G06Q 20/4015

(57) ABSTRACT

System for peer-to-peer lending, comprises a first borrowing customer application and a second lending customer application. The borrowing customer application requests a loan and detects a current location, the current location being transmitted with the loan request. The current location is inserted along with the loan request into a view shown at the second lending customer application to enable lending customers to consider a borrower's location when deciding whether to provide a loan.

### RELATED APPLICATION

This application claims the benefit of priority of U.S. Provisional Patent Application No. 62/972,003 filed on 9 Feb. 2020, the contents of which are incorporated herein by reference in their entirety.

### FIELD AND BACKGROUND OF THE INVENTION

The present invention, in some embodiments thereof, relates to a method and apparatus for location based crowdfunding and, more particularly, but not exclusively, to a location based method for peer to peer lending in a retail credit environment.

Crowdfunding, the ability to source money in small amounts from large numbers of people via the Internet, has been part of the financial world for some time now. Peer-to-peer lending, where lending platforms allow borrowers to take out loans, which are funded by other users of the platform, are also part of the Fintech world.

None of the above, however, provide loans on demand in small amounts at the retail level, and loans for retail are the domain of the retailers themselves via store credit and of the credit card companies.

Furthermore, retail loans are a type of loan that is requested over a short timescale, so that requests for crowdfunding of a retail loan that are simply launched on a crowdfunding platform would cease to be relevant by the time most of the users of the platform had seen them.

### SUMMARY OF THE INVENTION

The present embodiments may use location to determine physical proximity in order to direct retail-size requests for credit to potential funding partners. Movement and activity data may additionally be used to determine that the requests are being sent to an active user. The potential funding partners, the lenders, are provided with a platform for lending and thus earning interest, and location information may give them confidence in the borrower. The retailer may expect increased sales as customers are able to borrow. In addition commissions may be allocated by the system based on current location and borrowing customers may direct their allocations to the lender to boost their repayments, either to pay interest or to reduce the time to repayment of the loan.

Embodiments may provide a system for peer-to-peer lending, comprising a first borrowing customer application and a second lending customer application, the borrowing customer application configured to request a loan and detect a current location, the current location being transmitted with the loan request, the current location being inserted along with the loan request into a view shown at the second lending customer application to enable lending customers to consider a borrower's location when deciding whether to provide a loan.

According to a first aspect of the present invention there is provided a platform for peer-to-peer retail lending, comprising:

a central component; and

a plurality of customer applications running on mobile computing devices, the mobile computing devices having location determination units and motion sensing units, the customer applications respectively comprising:
a location and motion interface, the location and motion interface being configured to obtain location and motion data from the location determination units and the motion sensing units on the mobile computing devices;
a request issuance interface, into which a first customer enters a request;
a request processing unit associated with the request issuance interface and the location and motion interface, the request processing unit being configured to obtain a first customer current location from the location and motion interface and further to obtain the request from the request issuance interface and issue the request, the request being combined with the first customer current location such that the first customer current location is transmitted with the request,
a request view and acceptance interface for showing requests received via the platform from other customers, the request view and acceptance interface configured to show the first customer current location along with the request to enable consideration of a requester's location when deciding whether to respond to a given request;

the central component comprising:
an input for receiving requests from requesting customers;
a targeting unit associated with the input unit, the targeting unit being configured to obtain updated current location data and motion sensing data from the plurality of customer applications and being configured to identify, for a given request received from the input unit, using the location data and the motion sensing data of the plurality of user applications, other customers having at least a threshold probability of responding to the given request; and
a transmission unit, associated with the targeting unit for sending received requests to the other customers identified as having the at least threshold probability.

In embodiments, the requests are simply requests for recommendations or for information, for example concerning intended retail purchases, or regarding an organization or business. In other embodiments the requests are retail loan requests associated with an interaction between the first user and a business user.

In embodiments, the platform may send the requests to other users in conjunction with data regarding the business user, the request view and acceptance interfaces being configured to display or play the data regarding the business user.

The platform may obtain a commission for the data regarding the business user.

The platform may allocate the obtained commission to the other customers based on the current location.

The platform may allocate commission of a requesting customer to a corresponding lending customer as a loan repayment.

In embodiments, the location and motion interface is configured to obtain a current location from one member of the group consisting of: the global positioning system (GPS), a connecting cellular network, and a connecting Wifi network.

In embodiments, the interaction is an interaction over a network, the location data further comprising a network address of at least one of the business user and the first customer.

In embodiments, the location data comprises a network address of both the business user and the first customer.

In embodiments, the interaction relates to a given product or product type or service or service type, the targeting unit further configured to use the product or product type or service or service type to further identify the other customers.

In embodiments, the targeting unit is further configured to use a transaction time to further identify the other customers.

In embodiments, the central component is cloud-based.

According to a second aspect of the present invention there is provided a platform for user interaction, the platform comprising a central component and client applications, the client applications running on mobile computing devices, the mobile computing devices having motion sensors, the client applications being configured to obtain motion data from the motion sensors, the platform being configured to obtain motion data from the client applications, and to infer therefrom that a given customer is active.

The platform may build user movement profiles, and to compare current movements with an accumulated movement profile to verify that the same person is handling the phone, the verification being used to authorize a transaction.

The platform may build up a movement profile over time and to close down interactions with a phone that has not shown movement over a predetermined amount of time.

The platform may build up a movement profile and to use the built up movement profile to distinguish between real and fake accounts.

According to a third aspect of the present invention there is provided a method for operating an electronic platform over a network for peer-to-peer retail requests including lending, the method comprising:

providing a networked central component; and

providing a plurality of customer applications to run on mobile computing devices, the mobile computing devices having location determination units and motion sensing units,

obtaining location and motion data from the location determination units and the motion sensing units on the mobile computing devices;

entering a request;

obtaining a first customer current location from the location and motion interface and obtaining the request from the request issuance interface

issuing the request, the request being combined with the first customer current location such that the first customer current location is transmitted with the request, at the central component, obtaining updated current location data and motion sensing data from the plurality of customer applications,

identifying, for a given request received from the input unit, using the location data and the motion sensing data of the plurality of user applications, other customers having at least a threshold probability of responding to the given request; and

sending received requests to the other customers identified as having the at least threshold probability; and

showing the requests at the identified other customers, including the first customer current location along with the request to enable consideration of a requester's location when deciding whether to respond to a given request.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Embodiments may be supplied in the form of an application for a mobile phone and may make use of the location abilities available on the phone.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a platform including a central component and user clients according to a first embodiment of the present invention; and

FIG. 2 is a simplified diagram showing various users being divided up according to physical location according to an embodiment of the present invention;

FIG. 3 is a simplified diagram showing the process of a customer using the platform to complete a transaction including a loan funded via the platform;

FIG. 4 is a simplified diagram showing a list of instalments provided to the customer for repaying the loan in FIG. 3;

FIG. 5 is a simplified diagram illustrating a cashback process following use of the platform by a customer;

FIG. 6 illustrates a distribution of cashback payments to different users of the platform;

FIG. 7 illustrates a distribution of cashback to users only within a given physical area according to embodiments of the present invention;

FIG. 8 is a simplified diagram illustrating a payment being made by a customer to a business according to an embodiment of the present invention;

FIG. 9 is a simplified diagram showing a business receiving a payment from the customer according to an embodiment of the present invention;

FIG. 10 is a simplified diagram showing how a client B of the platform may supply a loan to customer A according to embodiments of the present invention;

FIGS. 11, 12 and 13 illustrate how the providing of the loan causes cashback payments to A to be diverted to those who provided the loan, as long as the loan remains unpaid, according to embodiments of the present invention;

FIGS. 14 and 15 are schematic diagrams updating of client balances in the cases of a single lender and multiple lenders respectively, according to embodiments of the present invention.

### DESCRIPTION OF SPECIFIC EMBODIMENTS OF THE INVENTION

The present invention, in some embodiments thereof, relates to a method and apparatus for location based crowdfunding and, more particularly, but not exclusively, to a location based method for providing crowdfunding in a retail credit environment.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

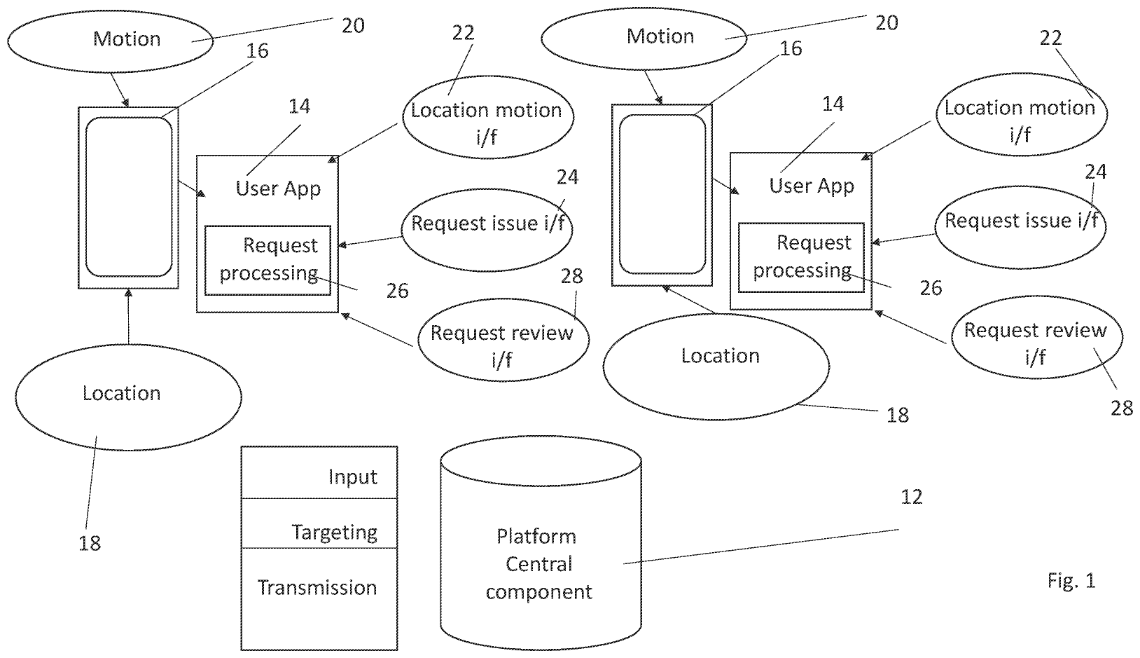

Reference is now made to FIG. 1 which is a simplified schematic diagram showing a platform 10 for peer-to-peer retail lending, which includes a central component 12 and customer applications 14 running on mobile computing devices 16. The customer applications are client devices of the platform, and the central component together with the clients make up the platform. The mobile computing devices include location determination units 18, generally based on GPS sensors, but also being able to interrogate any connected Wifi or cellular network to find out the location. The mobile computing device may also include motion sensing units 20 that obtain motion data from available sensors such as accelerometers and gyroscopes.

The customer applications include a location and motion interface 22 to obtain location and motion data from the location determination units 18 and from the motion sensing units 20 on the respective mobile computing device 16.

The customer application include a number of interfaces through which the users may interact with the platform. A request issuance interface 24, allows a customer to enters a request. For example the customer may be interacting with a particular business, for example shopping in a given shop, and may recommendations or customer experience about a given product or about the business. Alternatively, the customer may require credit in order to complete a transaction.

A request processing unit 26 is part of the customer application and is connected to the request issuance interface 24 and to the location and motion interface 22. The request processing unit 26 obtains the customer's current location from the location and motion interface 22. In addition the request processing unit 26 obtains the request currently being made at the request issuance interface and issues the request to the platform central component 12. The request as issued may include the customer's current location, so that the customer current location is transmitted with the request.

A request view and acceptance interface 28 is also part of the customer application. The view and acceptance interface 28 may display or play requests received over the platform from other customers. It is noted that the requests may include images and/or audio and/or video, and may include commercial material from the business with which the first customer is interacting. The request view and acceptance interface may additionally show the first customer's current location along with the request itself, and the reviewing customer is thus able to take into consideration to enable consideration the requester's location when deciding whether to respond to a given request.

The central component is the part of the platform that receives all requests made on the platform and decides how to distribute them for an optimal or maximal response as desired. The parameters for distribution may be set by the platform operator or they may depend on the businesses interacting in the platform, who may obtain different levels of service as required, for example by selecting a level of commission to pay.

The central component comprises three principle components, an input 30 for receiving requests from requesting customers, a targeting unit 32 and a transmission unit 34. The input and transmission units receive and send data over any suitable connection link and any available data transport system, such as the Internet and TCP/IP.

The targeting unit 32 is connected between the input unit and the transmission unit, and obtains updated current location data and motion sensing data from all currently active customer applications. Upon receipt of a request, the targeting unit then uses the location data and the motion sensing data in order to identify other customers having at least a threshold probability of responding to the current request. As will be discussed in greater detail below, there are numerous ways in which the targeting may be carried out, but one of the simplest is proximity. Any customer within a preset radius of the business may be identified as someone likely to be familiar with the business and thus respond positively to the request. Alternatively or additionally, customers who are not currently within a given radius of the business but have been shown to have been in proximity to the business in the recent past may be targeted. Alternatively or additionally, customers who are known to have purchased a similar product or service may be targeted, or customers who have expressed a particular interest may be targeted, and any combinations of the above may be used as well.

Thus, a request to know if a given jeweler can be trusted to sell good jewelry may be sent to people in proximity of a jeweler, and anyone familiar with the particular business may provide comments. The recipients of the request may receive the request itself, thus being reminded about the business, and the request may be combined with commercial content from the business. The business owner may pay a commission for the exposure.

In an embodiment, the request may be for credit by the customer to make a purchase. In this case, the platform may identify persons who are likely to be willing to lend money. Persons may be willing to lend money for that particular business or that kind of business or to people living in that area or to people answering to a given profile and the task of the platform is to identify such persons.

Alternatively or in addition, the platform may calculate geolocation centers of mass. That is to say areas in which lots of business is taking place may be identified. The transactions may be grouped according to type of business, type of product or service, or time. The potential lenders may be able to take the geolocation center of mass defined in general or for given types of business into account. Thus lenders may choose to be able to give loans only at peak business times, or to large centers of business, or only at lulls in business, as they prefer.

In an embodiment the commission paid by the business owner may be distributed among the people receiving or actively responding to the request. In a further embodiment, if a customer takes a loan over the system, then any commissions due to that customer may be diverted to help pay back the loan. In an embodiment, the borrower continues to pay back according to the original schedule, but stopping when the commissions cause the loan to be fully paid back. Thus the requests are retail loan requests associated with an interaction between a customer and a business user. The central component may be cloud-based or alternatively may be located on one or more servers.

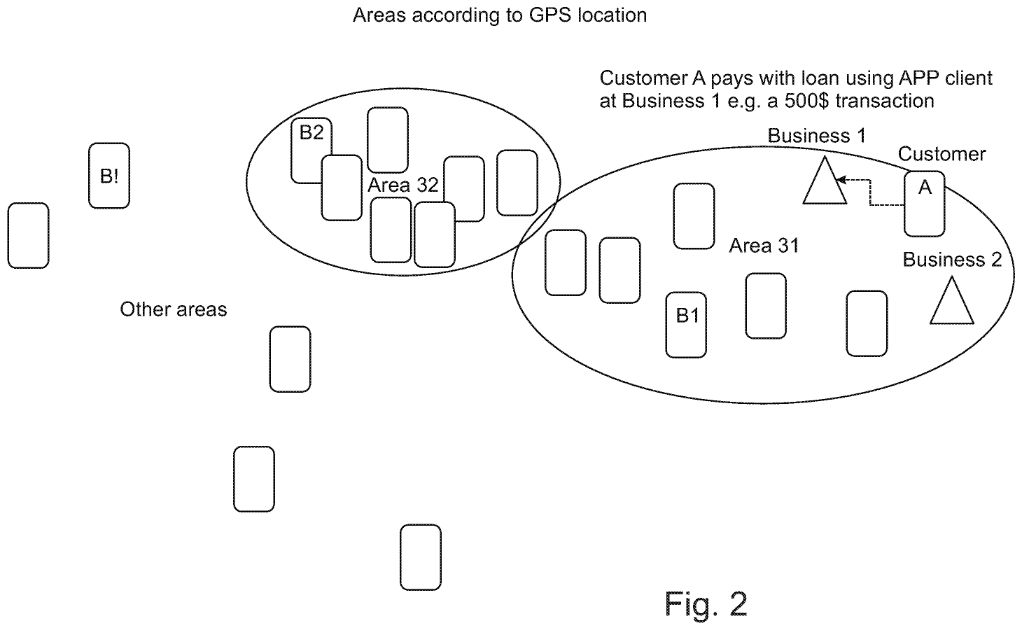

The embodiments are now considered in greater detail. FIG. 2 illustrates a business 1 and an area 1 defined by a given radius that includes the business. A customer A wishes to make a purchase at business 31. A client of the platform B1 happens to be in the area. Another client of the platform B2 is in a different area, area 32.

Client A wishes to carry out a transaction for $500.

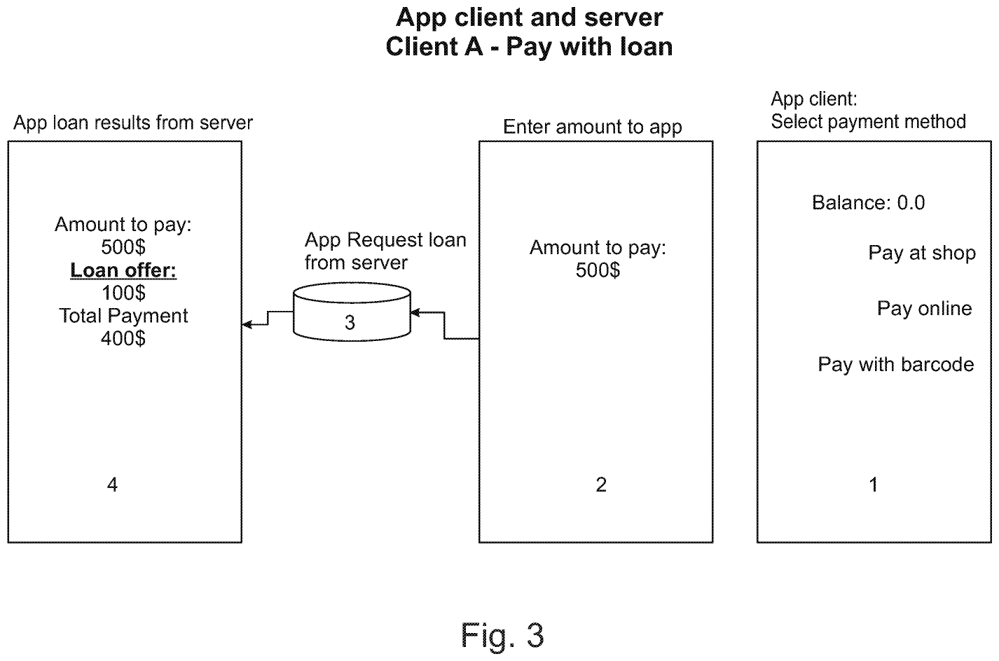

As shown in FIG. 3, client A queries as to whether a loan is available and is offered $100. The platform pays the business $100, the customer pays $400 and the customer ends up owing the platform $100.

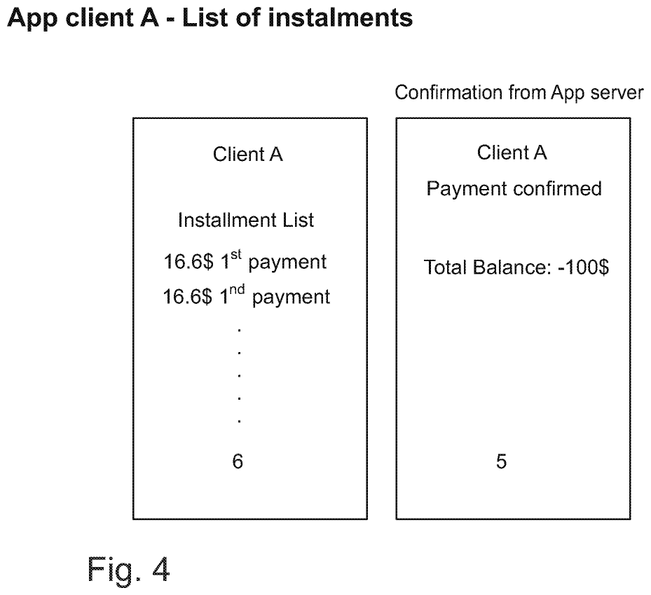

Referring now to FIG. 4 and client A is given a repayment schedule, the $100 being divided into six monthly installments. In one embodiment, commissions are used to pay the interest, so that the customer seemingly does not pay interest.

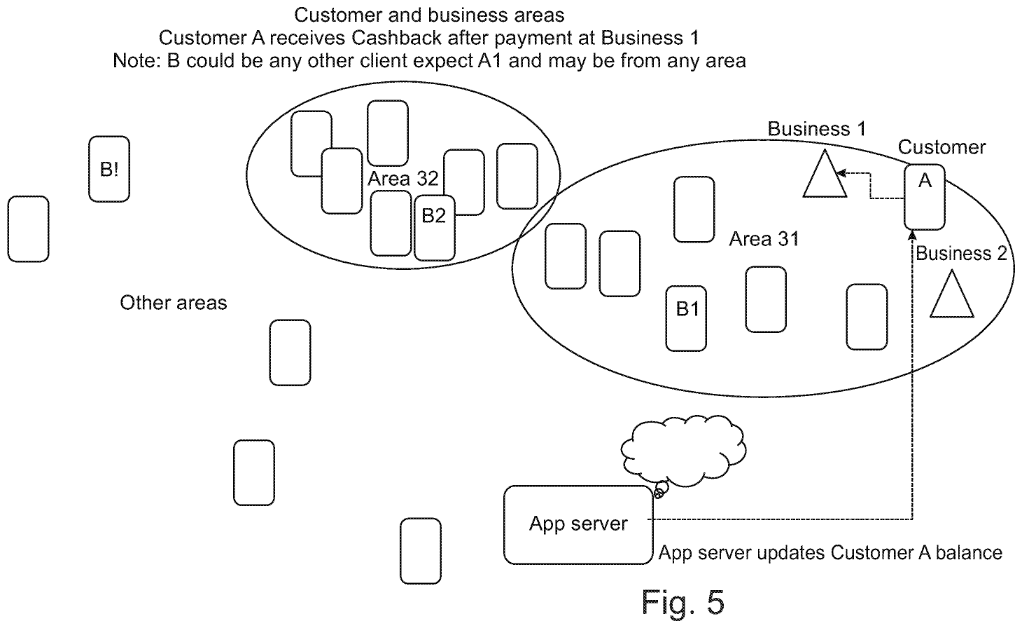

Reference is now made to FIG. 5. Customer A does business with business 1 and involves the platform for payment, say because of the loan referred to in FIGS. 2 and 3. Business 1 pays a commission to the platform for the privilege and some of that commission is available for distribution to customers. This distribution to customers is herein referred to as cashback.

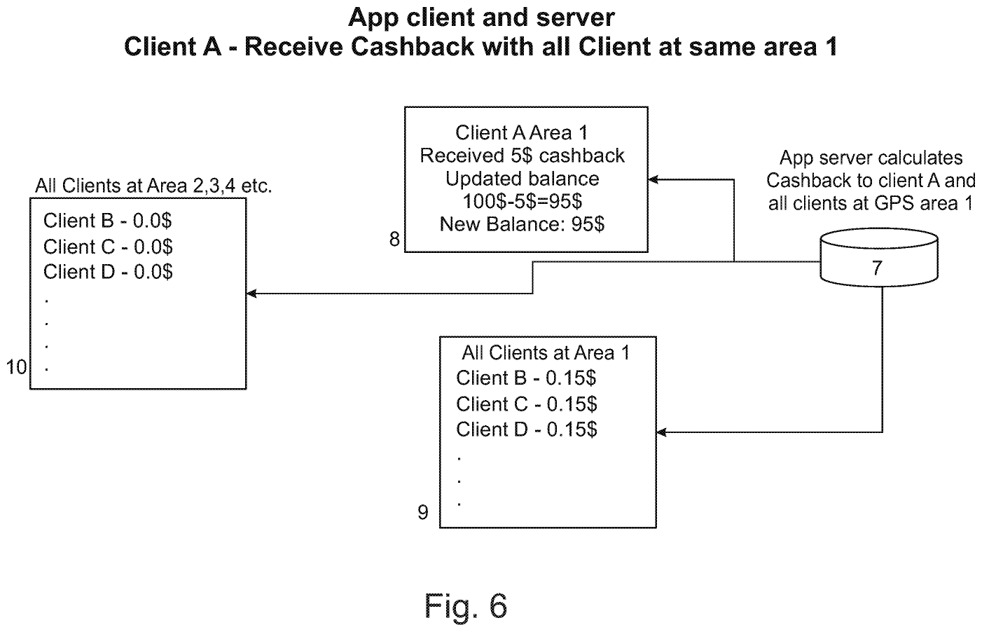

As shown in FIG. 6 a cashback is calculated. Most of the cashback goes to the customer client A who was involved in the transaction, but some of it is distributed to other customers who happen to be in the same area, as also shown in FIG. 6. The cashback could go to any of the platforms customers in the area, or could be reserved for those who interacted in some way with the request. Motion information from the customer application may be used to determine that a particular customer is currently in active mode and therefore eligible to receive the cashback.

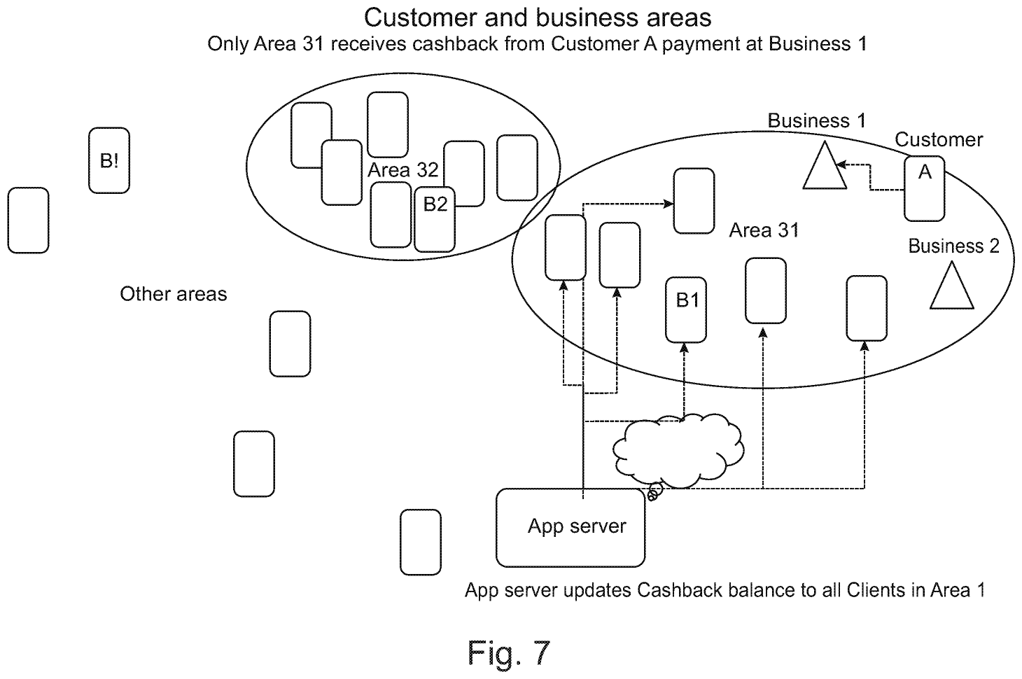

In FIG. 7 an example is given of how the platform server, the App Server, may distribute a commission for business 1. The request may be sent to all those customers of the platform within a given radius of the business in question. The cashback may be given to all customers receiving the request, or all customers who interact with the request, or all customers who respond to the request. In return for the commission, the business receives the custom of client A and also gets free exposure as the loan request is broadcast. As mentioned, the loan request may include commercial information about the business. As further mentioned, the request may not involve a loan at all but may simply be a request by the customer for information or recommendations about the product or business.

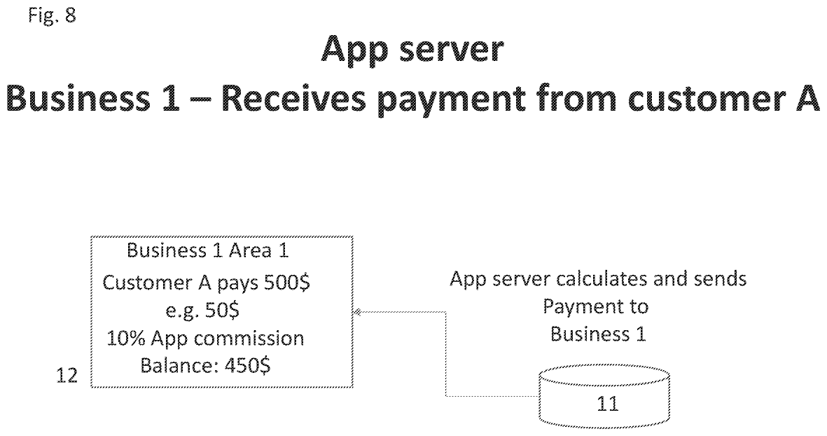

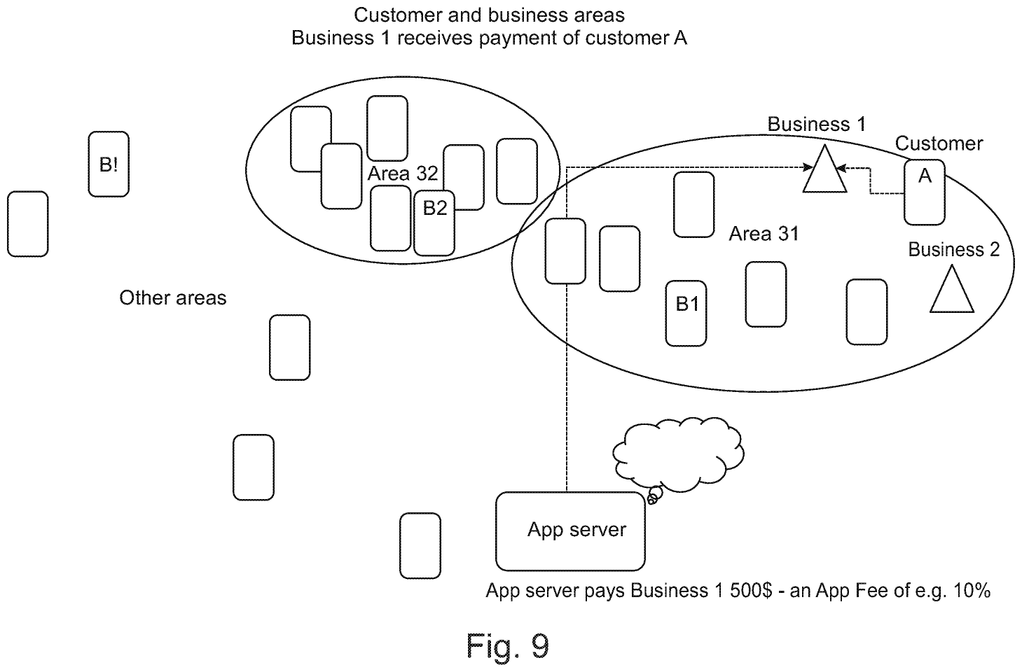

In FIGS. 8 and 9 a payment is made by the customer and by the platform to the business. The customer pays an amount from which the loan is deducted, and the platform pays the business the amount of the loan. A commission to the platform is deducted, from which the cashback is obtained.

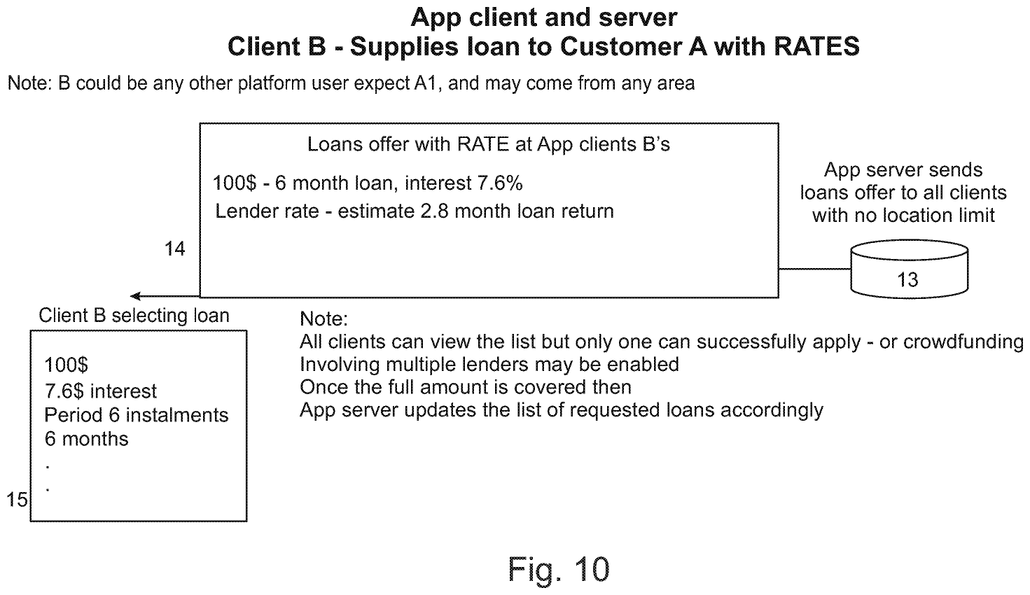

Reference is now made to FIG. 10, which introduces the part of client B, the loan provider. The lender is asked for a six month loan, on the basis of which an interest rate is calculated and a six month payment schedule is presented. All potential lenders may view the list of loans but only outstanding loans or parts of loans are shown. As soon as a loan request is covered it disappears from the list.

A notable feature is that the system may actually provide a faster payback than the six months of the loan schedule. The borrowers are indicated by their location so that the lenders know where the borrowers are and may draw any conclusions. The lenders are not limited in this way.

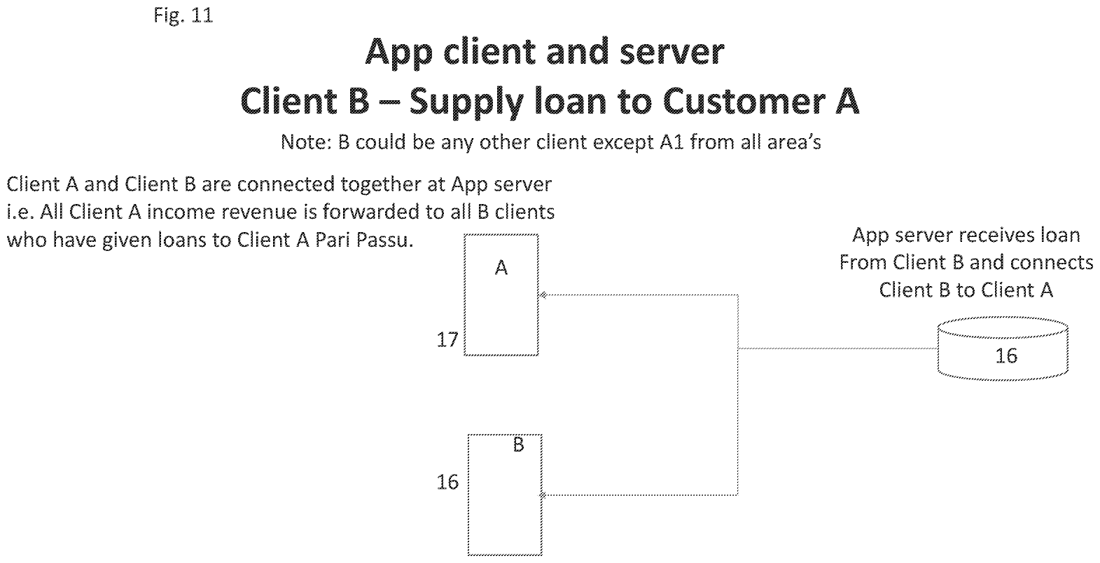

Referring now to FIG. 11 and client (or clients) B supply the loan. From this point on until the loan is repaid, all revenue accruing to A from cashbacks, or any loan A has made, are forwarded to B, so as to contribute to A's repayment of the loan. These payments thus boost the repayment schedule. In some embodiments it may be desirable to have a single lender covering a single loan, and in other cases genuine crowdfunding may be allowed to cover a loan, thus utilizing the network effect of the Internet to obtain credit.

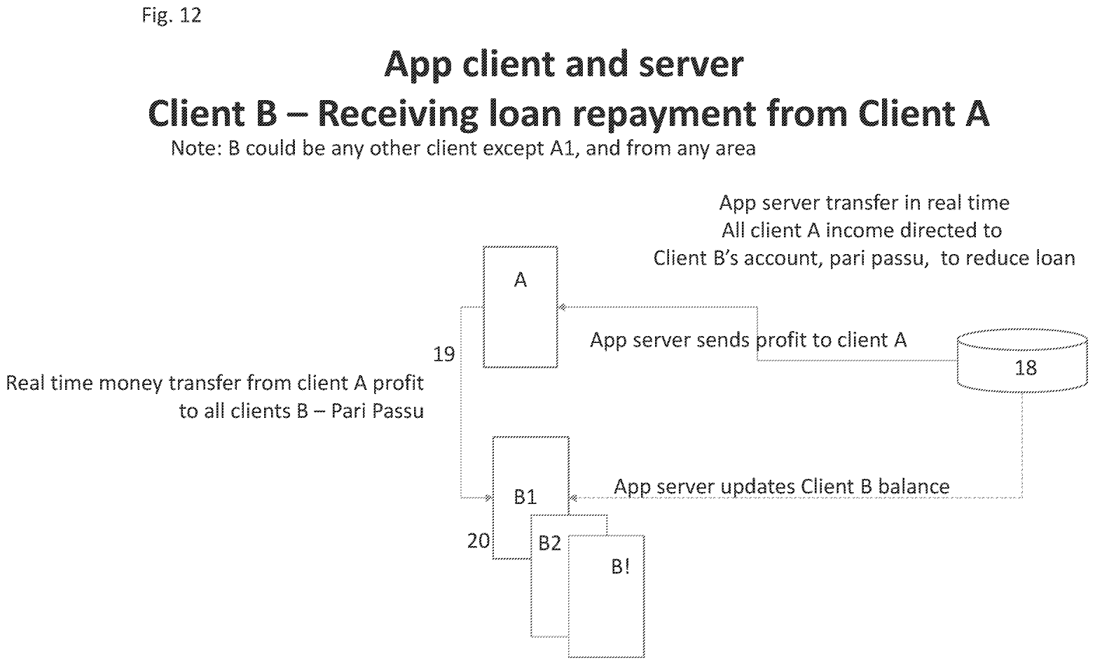

FIG. 12 illustrates the forwarding of the cashback payments due to A to the one or more lenders B.

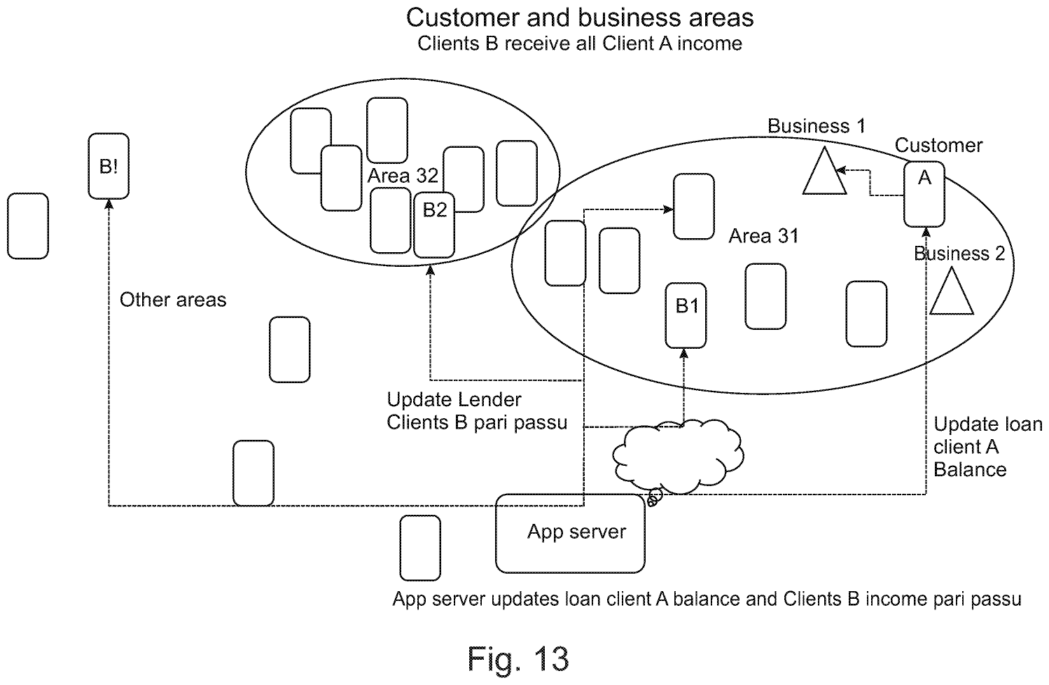

FIG. 13 illustrates how the cashback payments are made in real time. The accounts may be updated in real time.

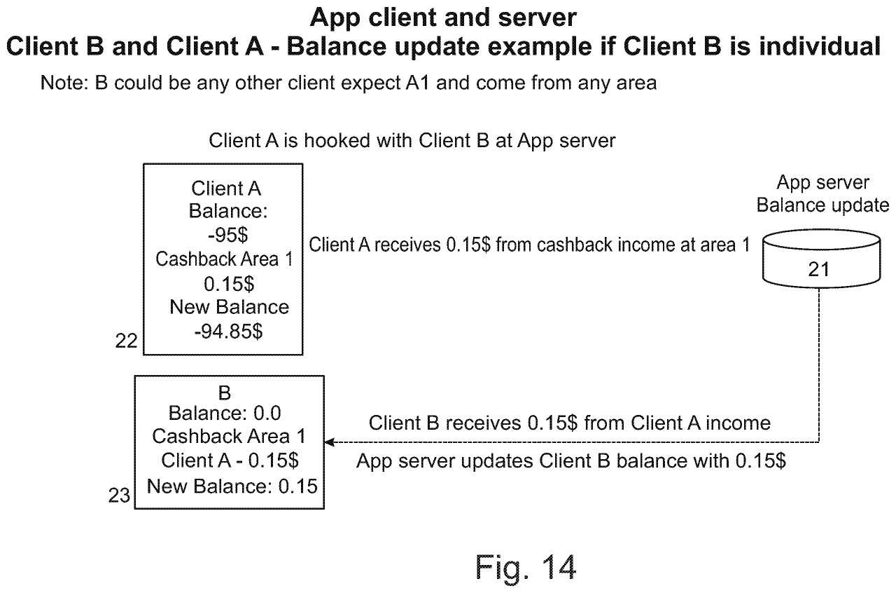

FIG. 14 illustrates updating where the lender is a single individual.

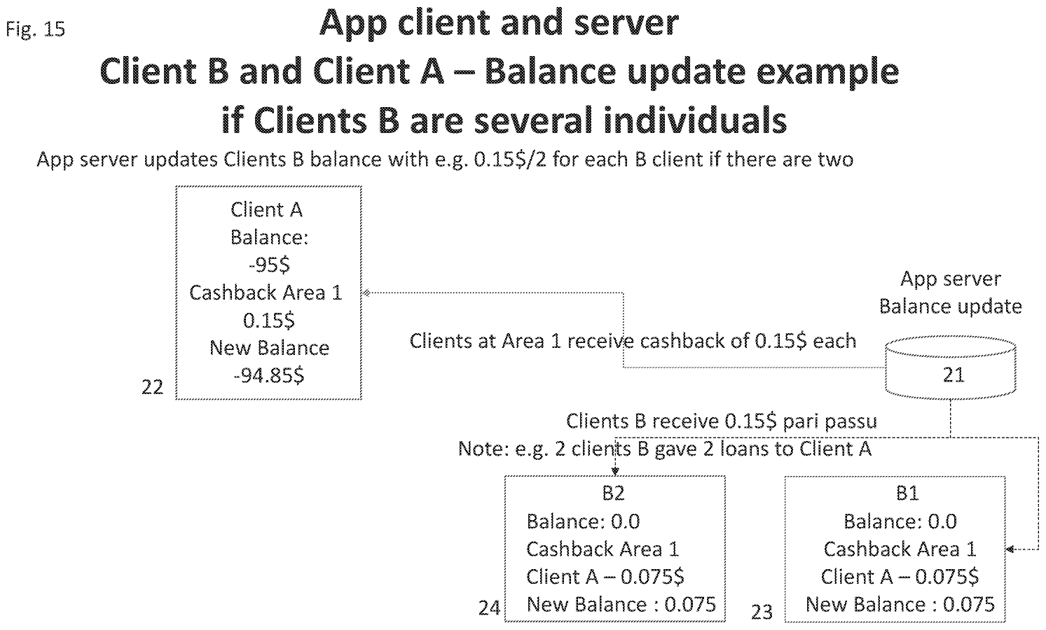

FIG. 15 illustrates the real time update where the lender is several individuals.

The present embodiments may provide peer to peer location base crowd funding in which a customer in a shop is able to obtain information about a business, or is able to obtain credit for purchases from another user of the same platform, a lending partner or lending peer. The lending partner may receive an offer over the system of the present embodiments to provide a loan, and the offer may include a repayment schedule and an estimate of the reliability of the borrowing peer.

The reliability estimation is obtained by rating each of the borrowers by their total personal liabilities on the platform as well as the situation for peers overall at the same GPS location.

The same GPS location is a variable in the system that may be set according to determined GPS location within a radius X that is set to cover a particular socio-economic mix so that the reliability estimation is accurate. Within the defined radius loan requests are shared, so that the potential lenders know which socio-economic group they are lending to, and interest rates may be selected to recognize the locally-defined risk. Irrespective of socio-economic group, lenders are more likely to feel confident that the recipient of the loan is not totally unknown, and irrespective of the lender, the borrower has some idea of the nature of the locality and what he/she is likely to receive. The speed of approval of the loan and the size may thus be very geographically dependent, varying according to mutual levels of confidence in ones neighbors, as well as the size of the retail world at that location. Where there are more transactions going on, loans should be available faster.

The present embodiments may thus enable the borrower to receive loans faster, ideally within the timescale of being in the queue at the checkout, and to avoid commission costs.

The system may be updated in real time for variations in risk, to vary interest rates, and to update balances of all of the clients, i.e. lenders and borrowers.

On the platform of the present embodiments, a new kind of advertising is made available. The push notice or text message or the like asking for the loan may detail the business where a purchase is contemplated and thus the business gains exposure to the potential loan partners.

The platform may receive commission from the businesses it supports, both because it gives them their customers the opportunity to buy something they might otherwise be unable to afford, and because it provides publicity every time someone requests a loan. The system may supply a proportion, say 60% of the commission, as contributions to interest payments to the lenders, so that the borrowers pay back their loans faster, or as cash back, to all client located, as indicated using the GPS at their handsets, near a business in which a transaction on the platform may have occurred.

Thus, in embodiments of the invention, the borrower may be able to obtain credit any point of sale (P.O.S) location.

If the lender is at a popular GPS location then he/she is able to provide more loans and earn income faster, since the cashbacks are added faster to the repayments so that the loan is paid back sooner than scheduled and may be lent out again. That is to say, if the lender is more active then, based on the location, the rate at which the loaned money returns is higher.

In embodiments, the business obtains additional exposure every time a customer looks for credit to enable a purchase.

In embodiments the potential lender receives a loan offer with a repayment schedule. Commission may be paid immediately while the loan is paid back in instalments. However, the cashback feature may provide that the loan and interest are paid back sooner, since the cashback is provided in real time and balances are immediately adjusted.

Hence a borrower may hope that some of his outstanding debt is covered by the cashback. The lender may hope to receive the loan plus interest more quickly and the capital is thus available sooner to provide for further lending. The platform owner receives the balance of the commission and is able to provide a lending system without needing to provide capital.

There are many circumstances in which platforms and other services offering perks and rewards may wish to know if a customer is active. Thus the feature of having a customer application that is able to extract motion information from the built-in sensors and report that the customer is active may have general application to platforms and subscription services.

In addition, the movement data of the customer may be built up into a profile. Different people have different movement profiles, which change very little over the course of a lifetime. Thus the platform may be able to use the movement profile to verify that the phone is with the legitimate user, and may refuse transactions on the basis that the movement profile is wrong.

Use of a movement profile may serve to identify dummy or fake accounts.

It is expected that during the life of a patent maturing from this application many relevant location technologies will be developed and the scope of the term ‘location-based’ is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the text is to be construed as if such a single embodiment is explicitly written out in detail. Conversely, various features of the invention, which are, for brevity, described in the context of a single embodiment, may also be provided separately or in any suitable subcombination or as suitable in any other described embodiment of the invention, and the text is to be construed as if such separate embodiments or subcombinations are explicitly set forth herein in detail.

Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated by reference in its/their entirety.

1. Platform for peer-to-peer retail lending, comprising:
a central component; and
a plurality of customer applications running on mobile computing devices, the mobile computing devices having location determination units and motion sensing units, said customer applications respectively comprising:
a location and motion interface, said location and motion interface being configured to obtain location and motion data from said location determination units and said motion sensing units on said mobile computing devices;
a request issuance interface, into which a first customer enters a request;
a request processing unit associated with said request issuance interface and said location and motion interface, the request processing unit being configured to obtain a first customer current location from said location and motion interface and further to obtain said request from said request issuance interface and issue said request, the request being combined with said first customer current location such that the first customer current location is transmitted with the request,
a request view and acceptance interface for showing requests received via said platform from other customers, said request view and acceptance interface configured to show said first customer current location along with said request to enable consideration of a requester's location when deciding whether to respond to a given request;
the central component comprising:
an input for receiving requests from requesting customers;
a targeting unit associated with said input unit, the targeting unit being configured to obtain updated current location data and motion sensing data from said plurality of customer applications and being configured to identify, for a given request received from said input unit, using said location data and said motion sensing data of said plurality of user applications, other customers having at least a threshold probability of responding to said given request; and
a transmission unit, associated with said targeting unit for sending received requests to said other customers identified as having said at least threshold probability.

2. The platform of claim 1, wherein said requests are retail loan requests associated with an interaction between said first user and a business user.

3. The platform of claim 2, being configured to send said requests to other users in conjunction with data regarding said business user, said request view and acceptance interfaces being configured to display or play said data regarding said business user.

4. The platform of claim 3, being configured to obtain a commission for said data regarding said business user.

5. The platform of claim 4, being configured to allocate said obtained commission to said other customers based on said current location.

6. The platform of claim 5, being configured to allocate commission of a requesting customer to a corresponding lending customer as a loan repayment.

7. The platform of claim 1, wherein said location and motion interface is configured to obtain a current location from one member of the group consisting of: the global positioning system (GPS), a connecting cellular network, and a connecting Wifi network.

8. The platform of claim 2, wherein said interaction is an interaction over a network, said location data further comprising a network address of at least one of said business user and said first customer.

9. The platform of claim 8, wherein said location data comprises a network address of both said business user and said first customer.

10. (canceled)

11. The platform of claim 2, wherein said targeting unit is further configured to use a transaction time to further identify said other customers.

12. (canceled)

13. A platform for user interaction, the platform comprising a central component and client applications, the client applications running on mobile computing devices, the mobile computing devices having motion sensors, the client applications being configured to obtain motion data from said motion sensors, the platform being configured to obtain motion data from said client applications, and to infer therefrom that a given customer is active.

14. The platform of claim 13, configured to build user movement profiles, and to compare current movements with an accumulated movement profile to verify that the same person is handling the phone, said verification being used to authorize a transaction.

15. The platform of claim 13, further configured to build up a movement profile over time and to close down interactions with a phone that has not shown movement over a predetermined amount of time.

16. The platform of claim 13, configured to build up a movement profile and to use said built up movement profile to distinguish between real and fake accounts.

17. Method for operating an electronic platform over a network for peer-to-peer retail requests including lending, the method comprising:
providing a networked central component; and
providing a plurality of customer applications to run on mobile computing devices, the mobile computing devices having location determination units and motion sensing units,
obtaining location and motion data from said location determination units and said motion sensing units on said mobile computing devices;
entering a request;
obtaining a first customer current location from said location and motion interface and obtaining said request from said request issuance interface issuing said request, the request being combined with said first customer current location such that the first customer current location is transmitted with the request, at the central component, obtaining updated current location data and motion sensing data from said plurality of customer applications,
identifying, for a given request received from said input unit, using said location data and said motion sensing data of said plurality of user applications, other customers having at least a threshold probability of responding to said given request; and
sending received requests to said other customers identified as having said at least threshold probability; and
showing said requests at the identified other customers, including said first customer current location along with said request to enable consideration of a requester's location when deciding whether to respond to a given request.

18. The method of claim 17, wherein said requests are retail loan requests associated with an interaction between said first user and a business user.

19. The method of claim 18, comprising:
sending said requests to other users in conjunction with data regarding said business user; and
displaying or playing said data regarding said business user.

20. The method of claim 19, comprising obtaining a commission for said data regarding said business user.

21. The method of claim 20, comprising allocating said obtained commission to said other customers based on said current location.

22. The method of claim 21, comprising allocating commission of a requesting customer to a corresponding lending customer as a loan repayment.

23. The method of claim 17, comprising obtaining a current location from one member of the group consisting of: the global positioning system (GPS), a connecting cellular network, and a connecting Wifi network.

24. The method of claim 18, wherein said interaction is an interaction over a network, said location data further comprising a network address of at least one of said business user and said first customer.

25. The method of claim 24, wherein said location data comprises a network address of both said business user and said first customer.

26. The method of claim 17, wherein said interaction relates to a given product or product type or service or service type, said targeting unit further configured to use said product or product type or service or service type to further identify said other customers.

27. The method of claim 18, comprising using a transaction time to further identify said other customers.

28. (canceled)
